(19) United States
(12) Patent Application Publication
(10) Pub. No.: US 2009/0267246 A1
(43) Pub. Date: Oct. 29, 2009

(54) METHOD AND APPARATUS FOR MANUFACTURING LENTICULAR PLASTICS BY CASTING

(76) Inventors: Kenneth E. Conley, Matthews, NC (US); David Roberts, Hillsboro, WI (US)

Correspondence Address: Clements Bernard PLLC, 1901 Roxborough Road, Suite 250, Charlotte, NC, 28211, US

(21) Appl. No.: 12/111,455

(22) Filed: Apr. 29, 2008

(51) Int. Cl. B29D 11/00; B29D 7/01

(52) U.S. Cl. 264/1.34

(57) ABSTRACT

A method and apparatus for producing a lenticular plastic sheet from a material resin having a first surface and an opposite second surface employs a patterned chill roller having an outer surface defining a lenticular pattern thereon disposed adjacent and parallel to a nip roller so as to define a nip therebetween. A material resin is extruded onto the chill roller while in a molten state and begins to cool forming a sheet. Thereafter, the sheet passes into the nip so that the first surface of the sheet is in contact with the lenticular pattern of the chill roller. The lenticular pattern of the chill roller is subsequently transferred to the sheet.

### BACKGROUND OF THE INVENTION

1. Field of the Invention

The present invention generally relates to a casting method for manufacturing plastic films, and more particularly, the present invention relates to a casting-type manufacturing method and the associated apparatus for producing lenticular sheets or film having lens arrays located thereon in selected areas.

2. Description of the Related Art

There are known methods of producing very thin lenticular sheets or film. Typically, these methods involve coating a clear UV formulation onto a carrier web and curing the resin through the carrier web while it is held against an engraved cylinder. Another method is by extrusion coating a molten resin between a patterned roll and a carrier film. Both of these methods produce a two layer lenticular sheet or film. Having two layers disadvantageously provides concerns relating to the effect of having two different refractive indices, clarity, the bond of one layer to another and overall manufacturing costs.

Conventionally, there are also known methods of producing thin monolayer films such as through a circular die, known as “blown film,” Orientation and stretch of a flat film from a die can also produce very thin and stable film, such as Mylar, Celenar, etc. Disadvantageously, a uniform lenticular pattern cannot be put into these films as in both cases, the dimensions of the film changes drastically through the manufacturing process in order to compensate for gauge increase.

In seeking to produce quality monolayer lenticular sheets, manufacturers have relied upon sheet extrusion methods. These methods are capable of producing lenticular sheets or film in thicknesses of about 7 mil to ¼ inch. Typically, the sheet extrusion process uses an extrusion die to meter a molten resin into a nip consisting of two metal rolls. To produce a lenticular pattern, at least one of the rolls is engraved with a desired inverse lenticular pattern. Once the sheet passes through the nip, it is typically pulled along a manufacturing line to cool. The distance pulled oftentimes reaches 30 or more feet. By pulling the sheets along the manufacturing line, they are undesirably necked or shrunk. This necking distorts the lineal lenticular pattern and decreases the overall quality.

Accordingly, to overcome the various disadvantages in the art, manufacturers are looking for solutions which produce thin lenticular sheets or film which provide superior clarity and quality. In one solution, it would be desirable to provide a casting method of manufacture and apparatus for producing engraved lenticular sheets or film having lens arrays located in selected areas. Such a solution would be capable of producing lenticular sheets or film having thicknesses from about 3 mil (having about 300 or more lenses per inch) to about 15 mil (having about 75 or more lenses per inch). Further, such a solution would be capable of producing lenticular sheets or film that have improved stability and less shrinkage as those sheets or film produced by extrusion processes. Still further, such a solution would be capable of producing lenticular sheets or film which provide improved clarity of a final commercial product by rapidly cooling the same during manufacture.

### BRIEF SUMMARY OF THE INVENTION

To achieve the foregoing and other objects, and in accordance with the purposes of the invention as embodied and broadly described herein, the present invention provides various embodiments of a manufacturing method for engraved lenticular sheet products, and more particularly, the present invention relates to a casting manufacturing method for producing engraved lenticular sheets having lens arrays located thereon in pre-selected areas. In various embodiments, the present invention provides cylinders operable for engraving thin, flexible webs having a variety of lens shapes for use with commercial products and/or the like. The present invention provides significant advantages over the prior art.

According to one exemplary embodiment, a clear molten material resin which will form a layer of a lenticular sheet is contained in a reservoir. The reservoir is operable for feeding the molten material resin through a flange or opening and into a slot or flat die. The die is operable for extruding the material resin onto a chill roller and through a nip to form the lenticular sheet or film. In exemplary embodiments, the molten material resin wraps around the chill roller and through the nip before it is removed to idler rollers (not shown) or wind up rollers (not shown). Thus, by the time the lenticular sheet or film comes off the chill roller, it has reached substantially room temperature. Advantageously, by having the lenticular sheet or film reach room temperature prior to corning off the chill roller, maximum strength of the lenticular sheet or film is achieved. In exemplary embodiments, the chiller roller is positioned under the die with a nip roller positioned adjacent the chill roller. The molten material is extruded onto the chill roller and begins to cool such that it takes the form of the inverse lens pattern. In exemplary embodiments, the chill roller is positioned under the die at a distance from about 9 inches to about 3 feet.

In exemplary embodiments, the nip roller is substantially cylindrical and is constructed by a rubber or polymeric material. The nip roller is operable for aiding in transferring the inverse lens pattern from the chill roller to the material resin. The nip roller may be positioned adjacent the chill roller such that it presses against the chill roller. In this case, material may flow through the nip because the surface of nip roller is not rigid. In other exemplary embodiments, the nip roller may be constructed from steel or chrome to impart a mirror or patterned finish. In this case, nip may be adjusted to provide a gap appropriate for the desired thickness of the lenticular sheet.

In operation, the clear molten material resin is fed from the reservoir through the opening to the die. Thereafter, the die extrudes the clear molten material about the rotating chill roller. The molten material rotates about the chill roller and begins to cool, thereby taking the form of the inverse lens pattern engraved upon the chill roller. Further, the molten material passes through the nip formed by the chill roller and nip roller. The molten material resin solidifies along its path at an unspecified point and emerges as a lenticular sheet or film. The lenticular sheet is thereafter wound up by additional rollers or reverse printed with an image using any known method.

### BRIEF DESCRIPTION OF THE DRAWING(S)

These and other features, aspects and advantages of the present invention are better understood when the following detailed description of the invention is read with reference to the accompanying drawing(s), in which:

FIG. 1 is a perspective view of an exemplary casting manufacturing system for lenticular sheets or film constructed in accordance with the present invention.

### DETAILED DESCRIPTION OF THE INVENTION

The present invention will now be described more fully hereinafter with reference to the accompanying drawing(s) in which exemplary embodiments of the invention are shown. However, this invention may be embodied in many different forms and should not be construed as limited to the embodiments set forth herein. These exemplary embodiments are provided so that this disclosure will be both thorough and complete, and will fully convey the scope of the invention to those skilled in the art. Like reference numbers refer to like elements throughout the various drawing(s).

The present invention provides various embodiments of a casting method of manufacture and apparatus for producing engraved lenticular sheets or film having lens arrays located in selected areas. As is well known and understood in the art, lenticular lens material utilizes rows of simple and commonly dome-shaped lenses or “lenticules.” It will be understood by those skilled in the art that any lens element may be used in accordance with the present invention either singularly or in combination such as, and without limitation, lineal, fresnel, dot (also known as integral or fly's eye), or prismatic. As used herein, the term “lenticular sheet” or “lenticular film” is intended to include any optical sheet, roll, film or material that is suitable for use in the printing arts and has a substantially transparent quality. Material compositions of such sheets or film may include, for example and without limitation, polyolefin, polycarbonate, polypropylene, polyester, polyethylene, polyvinylchloride, and polystyrene. All such material compositions are considered to be polymeric and are synonymous therewith. In one example, the lenticular sheet or film generally comprises a first, flat side and a second, lenticulated side including the lenticules forming the lens arrays

Advantageously, by using the disclosed methods of manufacture and apparatus of the present invention, lenticular sheets or film can be produced having superior qualities over conventionally manufactured lenticular sheets or film. By way of example, the lenticular sheets or film of the present invention may be produced having thicknesses from about 3 mil (having about 400 or more lenses per inch) to about 15 mil (having about 100 or more lenses per inch). By way of another example, lenticular sheets or film produced by the disclosed methods and apparatus have improved stability and less shrinkage as those sheets or film produced by extrusion processes. By way of yet another example, since the lenticular sheets or film of the disclosed methods are rapidly cooled, overall clarity of the final product is improved.

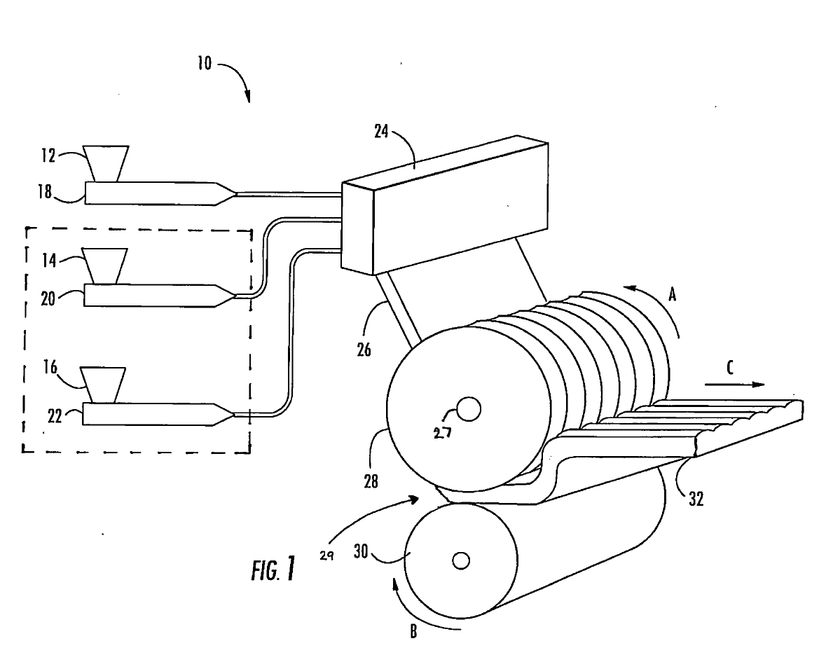

Referring now to FIG. 1, an exemplary embodiment of the present invention is illustrated in which a monolayer lenticular sheet 32 is produced. As illustrated, an engraved, substantially cylindrical chill roller 28 is provided and is central to the apparatus 10 and method of manufacture. It will be understood by those skilled in the art that the chill roller 28 may be any conventional type chill roller and in exemplary embodiments is provided with a relatively large diameter and is cooled with water flowing through a central core 27.

In accordance with one exemplary embodiment of the present invention, the lens arrays engraved on lenticular sheets or film are fabricated by first designing a cutting tool, such as a stylus, with a desired lens shape such that an inverse of the same can be transferred to the chill roller 28. The cutting tool (not shown) is preferably made of a diamond or carbide, however, it will be understood by those skilled in the art that any hard material suitable for engraving cylinders may be used. The shape of the cutting tool is dictated by the desired visual effect,

Once the cutting tool is designed, a desired inverse lens shape is engraved into pre-selected portions of the chill roller 28 using any known, conventional method of engraving, thereby forming a plurality of inverse lens arrays or patterns. In one exemplary embodiment, the chill roller 28 is placed in an engraving or CNC turning lathe which can accurately guide an engraving head, the cutting tool, across the surface of the roller 28. Preferably, the engraving process includes the use of a programmable computer operable for directing the cutting action and placement of the cutting tool in both direction and depth such that bands of optimal lens patterns are transferred into the roller 28 which are areas where light from a scanning device will be deflected or reflected in a different direction from smooth adjacent unengraved areas on the roller 28, or simply to scatter light. Each of the engraved bands of lenses can be just one cut or a series of engravings consisting of a frequency of up to 2000 cuts per inch or more.

The shape of the engraving on each band of lens elements can be prismatic, lineal fresnel, lenticular or dot or any combination there of If the lens pattern is to be a dot repeating type of pattern, a vibrating tool or spinning tool holder is used. The shape of the engraving can be different on adjacent bands of lens elements, or different within the same band. Advantageously, by using the engraving process for the chill roller 28, a variety of inverse lens patterns can be engraved into the roller 28, thereby providing a variety of lens patterns embossed on the same sheet, including but without limitation, lens patterns having different shapes and lens patterns extending in different directions such as longitudinally and latitudinally from a certain axis.

Subsequent to engraving the chill roller 28, the chill roller 28 is placed into the lenticular system or process of manufacture 10 of the present invention. As stated above, in exemplary embodiments, the lenticular sheet material 32 is preferably plastic or polymeric. Further, it will be appreciated by those skilled in the art, that a variety of materials can be employed for the production of the lenticular sheets or film, for example and without limitation, acrylics, polystyrenes, polycarbonates, polyesters, polyolefins, polyvinyl chlorides and all such polymeric equivalent materials.

As specifically shown in FIG. 1, a clear molten material resin 26 which will form a monolayer of the lenticular sheet 32 is contained in a reservoir 12. It will be understood by those skilled in the art that while a method of manufacture of a monolayer is being described herein, multiple layers may be manufactured from the disclosed process. In such cases, additional reservoirs 14 and 16 may be provided and may contain the same or distinct material resins. The reservoir 12 is operable for feeding the molten material resin 26 through a flange or opening 18 and into a slot or flat die 24. In exemplary embodiments, where a multilayered sheet is desired the molten material 26 is additionally fed from reservoirs 14 and 16 through openings 20 and 22, respectively, to the die 24. The die 24 is operable for extruding the material resin 26 onto the chill roller 28 and through a nip 29 to form the lenticular sheet or film 32. In exemplary embodiments, the molten material resin 26 wraps around the chill roller 28 and through the nip 29 from about 180 degrees to about 300 degrees before it is removed to idler rollers (not shown) or wind up rollers (not shown). Thus, by the time the lenticular sheet or film 32 comes off the chill roller 28, it has reached substantially room temperature. Advantageously, by having the lenticular sheet or film 32 reach room temperature prior to coming off the chill roller 28, maximum strength of the lenticular sheet or film 32 is achieved. In exemplary embodiments, the chiller roller 28, manufactured as described above, is positioned under the die 24 with a nip roller 30 positioned adjacent the chill roller 28. The molten material 26 is extruded onto the chill roller 28 and begins to cool such that it takes the form of the inverse lens pattern. In exemplary embodiments, the chill roller 28 is positioned under the die 24 at a distance from about 9 inches to about 3 feet.

In exemplary embodiments, the nip roller 30 is substantially cylindrical and is constructed by a rubber or polymeric material, such as Teflon®. The nip roller 30 may be positioned adjacent the chill roller 28 such that it presses against the chill roller 28. The nip roller 30 is operable for aiding in transferring the inverse lens pattern from the chill roller 28 to the material resin 26. In exemplary embodiments, the surface characteristic of the rubber or polymeric material which comprises the nip roller 30 is selected to impart a gloss like surface, and includes the use of very fine grain materials. In this case, material 26 may flow through the nip 29 because the surface of nip roller 30 is not rigid. In other exemplary embodiments, the nip roller 30 may be constructed from steel or chrome to impart a mirror or patterned finish. In this case, nip 29 may be adjusted to provide a gap appropriate for the desired thickness of the lenticular sheet 32. In other exemplary embodiments, the nip roller 30 may have an engraved pattern on its periphery such that the lenticular sheet 32 has two sides with patterns.

In operation, the clear molten material resin 26 is fed from reservoir 12 through the opening 18 to die 24. Thereafter, the die 24 extrudes the clear molten material 26 about the rotating chill roller 28 which rotates in the direction shown by arrow A. The molten material 26 rotates about the chill roller 28 and begins to cool, thereby taking the form of the inverse lens pattern engraved upon the chill roller 28. Further, the molten material 26 passes through the nip 29 formed by the chill roller 28 and nip roller 30, which is rotating in a direction shown by arrow B. The molten material resin 26 follows the path shown by arrows A, B, and C, solidifying at an unspecified point (not shown) along the path and emerging as a lenticular sheet or film 32. The lenticular sheet 32 is thereafter wound up by additional rollers (not shown) or reverse printed. It will be understood by those skilled in the art that roller rotation means (not shown) are provided to cause the chill roller 28 and the nip roller 30 to rotate. The precise means employed to cause the rollers 28 and 30 to rotate are not critical to the invention, however. After coming off of tie chill roller 28, the lenticular sheet or film 32 may be Corona treated or coated for ink adhesion. In exemplary embodiments, the lenticular sheet or film 32 may be identified with in line ink jet printing. In other exemplary embodiments, the lenticular sheet or film 32 may be provided with identifying or register marks. In still other exemplary embodiments, the lenticular sheet or film 32 may be reverse printed with a desired interlaced image by using known methods.

As briefly mentioned above, if a multilayer lenticular sheet is desired, additional material 26 is stored in additional reservoirs 14 and 16. The material 26 for the middle layer may be contained in reservoir 14 may be an adhesive layer. The specific material composition may vary. Further, the material 26 for the bottom layer may be contained in reservoir 16 and may be an adhesion layer. It will be understood by those skilled in the art that the lower layers are designed for cost reduction and adhesion to the final substrate in the final product, and need not be as hard as the top layer, as they are protected by the top layer.

If such a multilayered sheet 32 is desired, it will be understood that in exemplary embodiments, the lenticular resin in reservoir 12 flows from the reservoir through lenticular resin opening 18; the adhesive material in reservoir 14 flows from the reservoir through opening 20, and the adhesion material in reservoir 16 flows through opening 22. The various material resins contact flow through a conduit (not shown) and enter the flat or slot die 24. The compositions, temperature, pressure and flow rates may be selected so that little or no shear exists at the interfaces of the molten materials when they contact each other. Once in the die 24, the composition material 26 is extruded through the die 24 and about the rotating chill roller 28. Thereafter, the composition material 26 begins to cool and passes through the nip 29. The inverse lens pattern of the chill roller 28 is impressed onto the sheet 32 and the surface characteristic of the nip roller 30 is impressed onto the opposing side of the sheet 32.

It is to be understood by those skilled in the art that, any number of layers from one to about five may be produced using the appropriate number of materials and extrusion means, with the number of layers and their composition being selected in accordance with the desired end use of the lenticular sheet 32. (More than five layers are possible, and thus, this number should not be construed as a limitation on the invention; however, use of the preferred process and apparatus may, as a practical matter, become less convenient). It should be noted that, although the exemplary embodiments are described as providing a lenticular pattern, any pattern, lenticular or not, that directs rays of light to an appropriate predetermined portion of the sheet may be provided in accordance with the scope of the invention. It will also be understood by those skilled in the art that while the foregoing describes a method of manufacture whereby an image is reverse printed on the lenticular sheet 32 after coming off the chill roller 28, an interlaced image or printed web may be fed from a source (not shown) into the nip 29 and over the nip roller 30 such that it is adhered to the lenticular sheet 32 directly. In such an instance, final product will be produced directly off the casting line.

Once the lenticular sheet 32 is released, its edges can be trimmed to provide a uniform width and to remove irregular edges. It may also be desirable to remove the edges because the unequal shrinkage of the top and the bottom of the lenticular sheet 32 may subject the edges to additional stress, which could result in poorer optical quality at the edges of the material. In other exemplary embodiments, the lenticular sheet 32 is sheeted as opposed to rolling the product.

The foregoing is a description of various embodiments of the invention that are provided here by way of example only. Although the apparatus and casting method for producing the engraved lenticular sheets or film has been described with reference to preferred embodiments and examples thereof, other embodiments and examples may perform similar functions and/or achieve similar results. All such equivalent embodiments and examples are within the spirit and scope of the present invention and are intended to be covered by the appended claims. Although specific terms are employed herein, they are used in a generic and descriptive sense only and not for purposes of limitation.

1. A method of producing a lenticular sheet or film comprising the steps of:
providing an engraved chill roller having an inverse lens pattern formed thereon;
providing at least one molten material resin;
extruding the at least one material resin through a die and about the engraved chill roller; and
casting a lenticular sheet by rapidly cooling the at least one molten material resin to substantially room temperature and forming the inverse lens pattern onto a side of the rapidly cooled molten material resin which is in contact with the chill roller.

2. The method of claim 1, wherein the step of providing an engraved chill roller comprises the steps of:
creating as cutting tool;
engraving a metal cylinder with cutting tool to form an inverse lens pattern in pre-selected areas;
using the engraved cylinder in an casting process such that the molten material resin can be impressed with the lens pattern.

3. The method of claim 2, wherein the step of engraving the cylinder further comprises the steps of:
utilizing a computer to control and direct the direction and depth of the engraved lens pattern.

4. The method of claim 1, wherein the formed lenticular sheet has a thicknesses from about 3 mil to about 15 mil.

5. The method of claim 1, wherein the at least one molten material resin is selected from the group consisting of polyolefin, polycarbonate, polypropylene, polyester, polyethylene, polyvinylchloride, and polystyrene.

6. The method of claim 1, wherein the step of providing at least one molten material resin comprises the steps of:
storing the at least one molten material resin in in at least one reservoir; and
feeding the molten material resin into the die.

7. The method of claim 1, further comprising the steps of wrapping the extruded molten material resin around the chill roller.

8. The method of claim 1, further comprising the steps of positioning the chill roller under the die.

9. The method of claim 1, wherein the chill roller is positioned under the die from about 9 inches to about 3 feet.

10. The method of claim 1, further comprising the steps of:
providing a nip roller adjacent the chill roller to form a nip operable for aiding in the impression of the lenticular pattern to the material resin.

11. The method of claim 10, wherein the nip roller is constructed from the group consisting of rubber material, polymeric material, steel, metal, or chrome.

12. A method of producing a lenticular sheet or film comprising the steps of:
providing an engraved chill roller having an inverse lens pattern formed thereon;
providing a molten material resin;
extruding the molten material resin through a die and about the engraved chill roller;
providing a nip roller adjacent the chill roller to form a nip between the chill roller and the nip roller; and
forming a lenticular sheet by rapidly cooling the molten material resin about the chill roller to substantially room temperature, passing the cooled material resin through the nip and impressing the inverse lens pattern onto a side of the cooled material resin which is in contact with the chill roller.

13. The method of claim 12, wherein the step of providing an engraved chill roller comprises the steps of:
creating as cutting tool;
engraving a metal cylinder with cutting tool to form an inverse lens pattern in pre-selected areas;
using the engraved cylinder in an casting process such that the molten material resin can be rapidly cooled and impressed with the lens pattern.

14. The method of claim 13, wherein the step of engraving the cylinder further comprises the steps of:
utilizing a computer to control and direct the direction and depth of the engraved lens pattern.

15. The method of claim 12, wherein the formed lenticular sheet has a thicknesses from about 3 mil to about 15 mil.

16. The method of claim 12, wherein the step of providing a molten material resin comprises the steps of:
storing the molten material resin in a reservoir; and
feeding the molten material resin into the die.

17. The method of claim 12, further comprising the steps of positioning the chill roller under the die.

18. The method of claim 12, wherein the chill roller is positioned under the die from about 9 inches to about 3 feet.

19. A method of producing a lenticular sheet or film comprising the steps of:
storing a material resin in a molten state in a reservoir;
feeding the molten state material resin into a die;
providing an engraved chill roller having an inverse lens pattern formed thereon;
extruding the molten material resin through the die and about the engraved chill roller such that the molten material resin begins to rapidly cool to substantially room temperature;
providing a nip roller adjacent the chill roller to form a nip between the chill roller and the nip roller; and
forming a lenticular sheet by rapidly cooling the molten material resin about the chill roller, passing the cooled material resin through the nip and impressing the inverse lens pattern onto a side of the cooled material resin which is in contact with the chill roller.
